(19) United States
(12) Patent Application Publication
(10) Pub. No.: US 2012/0329328 A1
(43) Pub. Date: Dec. 27, 2012

(54) BUSBAR CONTACT PAD WITH SPECIFIC CURVATURE FOR A BETTER CONNECTION TO METAL SPRAY LAYERS

(75) Inventors: Dietmar Zeidler, Landsberg am Lech (DE); Witali Spitzer, Landsberg am Lech (DE); Ralf Deisenhofer, Senden (DE)

(73) Assignee: KEMET ELECTRONICS CORPORATION, Greenville, SC (US)

(21) Appl. No.: 13/530,833

(22) Filed: Jun. 22, 2012

(30) Foreign Application Priority Data
Jun. 22, 2011 (DE) 1020/11104993.6

(51) Int. Cl. H01R 13/66; H01R 13/02

(52) U.S. Cl. 439/620.24; 439/884

(57) ABSTRACT

Current busbar pad designs are based on a flat busbar surface to be connected to the metal spray layer of the film capacitor. Busbar pads with a special concave curvature allow better connections to metal spray layer surfaces in regard to mechanical adherence and an improved solder tin distribution at the interface. Best performance can be achieved in combination with flux.

### CROSS-REFERENCE TO RELATED APPLICATIONS

The present application claims priority to pending application DE 102011104993.6 filed Jun. 22, 2011.

### BACKGROUND

The present invention is related to improvements in busbar pads. In particular, a problem exist in the art wherein the connection between the busbar and spray layer connection is weak. This problem is solved by using a busbar pad design with a special curvature.

### SUMMARY

It is an object of the invention to provide an improved electrical component.

It is another object of the invention to provide an improved method for forming an electrical component.

These and other advantages, as will be realized, are provided in a busbar pad comprising a busbar surface with a concave curvature.

Yet another advantage is provided in a capacitor comprising a conductive film, a conductive spray layer on the conductive film and a busbar in electrical contact with the conductive spray layer wherein the busbar comprises a concave curvature.

### BRIEF DESCRIPTION OF FIGURES

FIG. 1 is a front view of a busbar.

FIG. 2 is a top view of a busbar pad.

FIG. 3 is a cross-sectional view.

FIG. 4 is a front view of a prior art busbar.

FIG. 5 is a cross-sectional view.

FIG. 6 is a diagrammatic representation.

FIG. 7 is a diagrammatic representation.

### DETAILED DESCRIPTION

The present invention is related to an improved busbar for connection to a metal spray layer of an electrical component. More specifically, the present invention is related to a busbar with concave curvature.

The invention will be described with reference to the various figures which form an integral, non-limiting component of the invention.

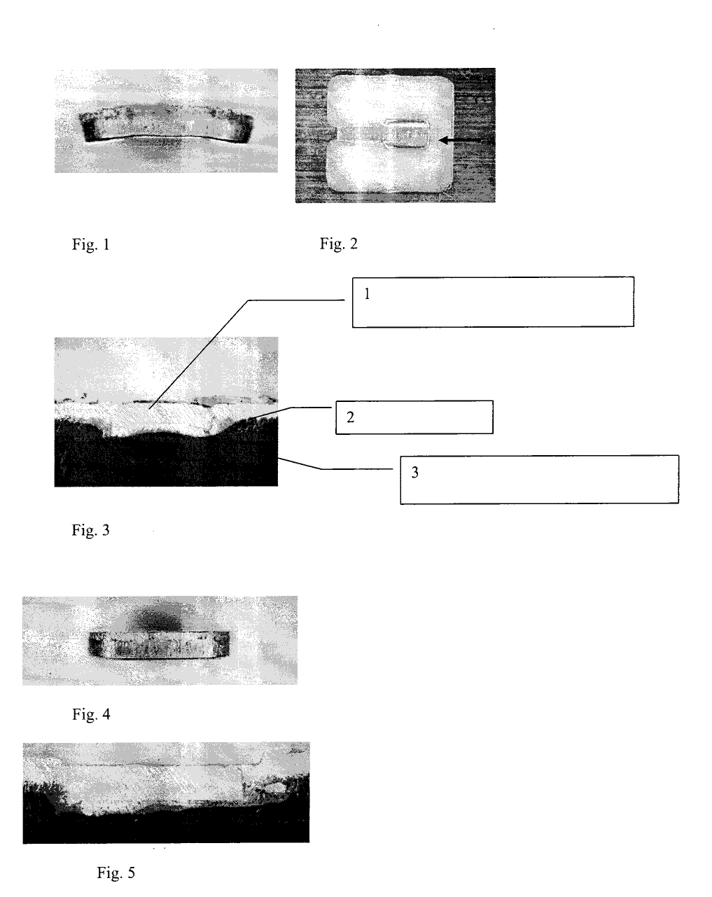

A front view of an inventive busbar is shown with concave curvature in FIG. 1. A top view of an entire busbar pad is shown in FIG. 2 wherein the arrow of FIG. 2 indicates the location of the front view in FIG. 1.

A cross-cut of a welded busbar pad with concave curvature is shown in FIG. 3 wherein flux is used. In FIG. 3, the central core, 1, of the busbar is copper. The Sn(Zn) layer of the capacitor spray layer is represented as 2 which has a very equal distribution under the busbar pad. The plastic film, 3, forms a capacitor core.

FIG. 4 is a front view on standard busbar pad without curvature.

FIG. 5 is cross cut of a welded standard busbar pad without curvature, welded without flux.

Just flux also would improve the welding connection but the curvature provides a boundary so that the Sn is kept more in the region under the pad and not spattered somewhere else.

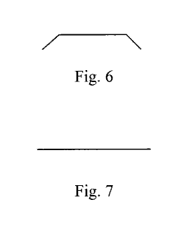

FIG. 6 is a schematic front view on busbar pad with concave curvature.

FIG. 7 is schematic front view on standard busbar pad without curvature.

The plastic film is a conductor of a capacitor and is not otherwise limited herein. Capacitor cores utilizing plastic film conductors are well known to those of skill in the art and further description is not necessary herein.

The invention has been described with reference to preferred embodiments without limit thereto. One of skill in the art would realize additional embodiments and improvements which are not specifically enumerated herein but which are within the scope of the invention as set forth in the claims appended hereto.

1. A busbar pad comprising a busbar surface with a concave curvature.

2. A capacitor comprising:
a conductive film;
a conductive spray layer on said conductive film; and
a busbar in electrical contact with said conductive spray layer wherein said busbar comprises a concave curvature.

3. The capacitor of claim 2 wherein said conductive spray layer comprises tin and zinc.
